(19) United States
(12) Patent Application Publication
(10) Pub. No.: US 2004/0038693 A1
(43) Pub. Date: Feb. 26, 2004

(54) Mobile communication system, mobile communication method, base station and mobile station

(76) Inventor: Kazuhito Niwano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/381,985

(22) PCT Filed: Aug. 1, 2001
(86) PCT No.: PCT/JP01/06627

(51) Int. Cl. H04Q 7/20

(52) U.S. Cl. 455/509; 455/447; 455/450

(57) ABSTRACT

A base station BS changes a receive-system band-limiting characteristic in a first communication channel band ΔF1 in accordance with volumes of communication in second and third communication channels ΔF2 and ΔF3. A first mobile station MS1 communicating in the first communication channel band ΔF1 is notified of the changed receive-system band-limiting characteristic. The first mobile station MS1 changes its transmit-system band-limiting characteristic in accordance with the changed receive-system band-limiting characteristic and also changes an operating point of a transmit-system power amplifier 105.

### TECHNICAL FIELD

The present invention relates to a mobile communication system and a mobile communication method for wireless communication between a plurality of mobile stations and a base station, base stations and mobile stations which are used in the mobile communication system and in which the mobile communication method is used. The invention relates more particularly to reduction of power consumption in the mobile stations.

### BACKGROUND ART

FIG. 1 shows a construction of a mobile communication system according to the related art, illustrating a circuit block of a base station (stationary communication station) and circuit blocks of three mobile stations (mobile communication stations). In the mobile communication system of FIG. 1, three adjacent communication channel bands are available for use and controlled using the same communication scheme. Each of the communication channels is used for wireless communication between the mobile station and the base station. In the following description, it is assumed that only one mobile station exclusively uses a corresponding communication channel band. Alternatively, a plurality of mobile stations may share a communication channel band.

Referring to FIG. 1, the mobile communication system comprises a base station BS, a first mobile station MS1, a second mobile station MS2 and a third mobile station MS3. The first mobile station MS1, the second mobile station MS2 and the third mobile station MS3 use a first carrier frequency f1, a second carrier frequency f2 and a third carrier frequency f3, respectively for communication with the base station BS. The first carrier frequency f1 is located at the center of a first communication channel band ΔF1 (given communication channel band), the second carrier frequency f2 is located at the center of a second communication channel band ΔF2 (adjacent communication channel band) and the third carrier frequency f3 is located at the center of a third communication channel band ΔF3 (adjacent communication channel band). The carrier frequencies are related to each other such that f3<f1<f2. The first communication channel band ΔF1 is located between the third communication channel band ΔF3 and the second communication channel band ΔF2.

The circuit block of the base station BS according to the related art is constructed as follows. Referring to FIG. 1, reference numeral 901 indicates a data signal (symbol) transmitted from the base station BS to the first mobile station MS1, 902 indicates a band-limiting (pulse shaping) root Nyquist filter for a transmit system, 903A, 903B and 903C indicate carrier oscillators respectively outputting carriers having carrier frequencies f1, f2 and f3, respectively, 904 indicates a frequency converter, 905 indicates a power amplifier in the transmit system, and 906 indicates a transmission/reception antenna.

Reference numeral 907 indicates a low noise amplifier for a receive system, 908A, 908B and 908C indicate frequency converters in the receive system, 909A, 909B and 909C indicate band-limiting (pulse shaping) root Nyquist filter in the receive system, 910A, 910B and 910C indicate demodulators, 911A, 911B and 911C indicate data signals (symbols) from the first mobile station MS1, the second mobile station MS2 and the third mobile station MS3, respectively, obtained as a result of demodulation in the demodulators 910A, 910B and 910C, respectively.

The circuit block of the first mobile station according to the related art is constructed as follows.

Referring to FIG. 1, reference numeral 101 indicates a data signal (symbol) transmitted from the first mobile station MS1 to the base station BS, 102 indicates a band-limiting (pulse shaping) root Nyquist filter in the transmit system, 103 indicates a carrier oscillator outputting a carrier having a carrier frequency f1, 104 indicates a frequency converter in the transmit system, 105 indicates a power amplifier for the transmission system and 106 indicates a transmission/reception antenna.

Reference numeral 107 indicates a low noise amplifier in the receive system, 108 indicates a frequency converter in the receive system, 109 indicates a band-limiting (pulse shaping) root Nyquist filter in the receive system, 110 indicates a demodulator, 111 indicates a data signal (symbol) from the base station BS obtained as a result of demodulation in the demodulator 110.

In FIG. 1, illustration of the internal block of the second mobile station MS2 and the third mobile station MS3 is omitted. Illustration of the internal block of the base stations BS associated with the second mobile station MS2 and the third mobile station MS3 is also omitted, except that transmission/reception antennas 206 and 306 are shown. The blocks omitted from illustration have the same construction as the illustrated blocks related to the first mobile station MS1.

A description will now be given of communication between the first mobile station MS1, the second mobile station MS2, the third mobile station MS3 and the base station BS performed in the mobile communication system according to the related art as described above.

Communication from the base station BS to the first mobile station MS1

Communication from the first mobile station MS1 to the base station BS

Communication from the second mobile station MS2 and the third mobile station MS3 to the base station BS

Communication From the Base Station BS to the First Mobile Station MS1

In the base station BS, the data signal 901 to be transmitted to the first mobile station MS1 is supplied to the root Nyquist filter 902. The frequency converter 904 mixes an output of the root Nyquist filter 902 with the carrier of the frequency f1 from the carrier oscillator 903A and subjects the resultant mixture to frequency conversion to obtain a signal having the center frequency f1 and the first communication channel band ΔF1. The signal produced as a result of frequency conversion is amplified by the power amplifier 905 to have a desired transmission power. The resultant signal is transmitted by radio from the transmission/reception antenna 906 to the first mobile station MS1.

The transmission/reception antenna 106 of the first mobile station MS1 receives the radio signal having the center frequency f1 and the first communication channel band ΔF1 transmitted by radio from the base station BS. The low noise amplifier 107 amplifies the received radio signal. Subsequently, the frequency converter 106 mixes an output of the low noise amplifier 107 with the carrier of the frequency f1 from the carrier oscillator 103 so as to produce a base band signal by frequency conversion from a radio signal band to a data signal band. An output of the frequency converter 108 is supplied to the demodulator 110 via the root Nyquist filter 109 for demodulation. As a result, the data signal 111 transmitted from the base station BS is reproduced.

Communication From the First Mobile Station MS1 to the Base Station BS

In the first mobile station MS1, the data signal 101 to be transmitted to the base station BS is supplied to the root Nyquist filter 102. The frequency converter 104 mixes an output of the root Nyquist filter 102 with the carrier of the frequency f1 from the carrier oscillator 103 and subjects the resultant mixture to frequency conversion to obtain a signal having the center frequency f1 and the first communication channel band ΔF1. The signal produced as a result of frequency conversion is amplified by the power amplifier 105 to have a desired transmission power. The resultant signal is transmitted by radio from the transmission/reception antenna 106 to the base station BS.

The transmission/reception antenna 906 of the base station BS receives the radio signal in the first communication channel band ΔF1 having the center frequency f1 and transmitted by radio from the first radio mobile station MS1. The low noise amplifier 907 amplifies the received radio signal. Subsequently, the frequency converter 908A mixes an output of the low noise amplifier 907 with the carrier of the frequency f1 from the carrier oscillator 903A so as to produce a base band signal by frequency conversion from a radio signal band to a data signal band. An output of the frequency converter 908A is supplied to the demodulator 910A via the root Nyquist filter 909A for demodulation. As a result, the data signal 911A transmitted from the base station BS is reproduced.

Communication From the Second Mobile Station MS2 and the Third Mobile Station MS3 to the Base Station BS

In a similar configuration as the first mobile station MS1, the radio signal in the second communication channel band ΔF2 having the frequency f2 and transmitted from the transmission/reception antenna 206 of the second mobile station MS2 is received by the transmission/reception antenna 906 of the base station BS. The received radio signal is amplified by the low noise amplifier 907. The frequency converter 908B mixes the amplified signal with the carrier of the frequency f2 from the carrier oscillator 903B for frequency conversion from a radio signal band to a data signal band. An output of the frequency converter 908B is supplied to the demodulator 910B via the root Nyquist filter 909B for demodulation to reproduce the data signal 911B.

In a similar configuration as the first mobile station MS1, the radio signal in the third communication channel band ΔF3 having the frequency f3 and transmitted from the transmission/reception antenna 306 of the third mobile station MS3 is received by the transmission/reception antenna 906 of the base station BS. The received radio signal is amplified by the low noise amplifier 907. The frequency converter 908C mixes the amplified signal with the carrier of the frequency f3 from the carrier oscillator 903C for frequency conversion from a radio signal band to a data signal band. An output of the frequency converter 908C is supplied to the demodulator 910C via the root Nyquist filter 909C for demodulation to reproduce the data signal 911C.

A Nyquist filter satisfying a Nyquist standard is a common choice for band-limiting applications in a transmit system and in a receive system. In a linear communication system, a product of a filter transfer function in a transmit system and a filter transfer function in a receive system is configured to have the characteristic of a Nyquist filter so that the overall transfer characteristic of the system including the transmit system and the receive system satisfies the Nyquist standard.

In a common practice, the overall transfer function is shared by the transmit system and the receive system such that each of the systems has a square-root (√) of the Nyquist filter characteristic (Nyquist frequency response). In the case of FIG. 1, the root Nyquist filter 102 of the first mobile station MS1 and the root Nyquist filter 909A of the base station BS both have a square-root of the Nyquist frequency response.

A brief description will now be given of the Nyquist filter characteristic.

FIG. 2 is a graph showing a Nyquist filter characteristic, in which the frequency is plotted horizontally and the relative amplitude (coefficient of amplitude) is plotted vertically. α indicates a roll-off (band-limiting) coefficient of the Nyquist filter and Fs indicates a symbol rate of the symbol to be transmitted.

In the Nyquist filter characteristic, the coefficient of amplitude is 1 when the frequency is 0. When the frequency is ½ Fs, the coefficient of amplitude is 0.5. The value of roll-off coefficient α determines the frequency at which the coefficient of amplitude becomes 0 and the characteristic of coefficient of amplitude. Since the frequency at which the coefficient of amplitude becomes 0 is (½+α)Fs, the value of roll-off coefficient α determines the signal bandwidth. Since band-limitation is effected using a Nyquist filter, the envelope of a radio signal transmitted from the transmission/reception antenna is fluctuated. The smaller the roll-off coefficient α, the larger the fluctuation.

In a personal handyphone system (PHS) according to the ARIB standard STD-28 currently in commercial service, a relatively low communication speed of 384 kbps and a relatively narrow signal bandwidth are required. Accordingly, a roll-off coefficient of α=0.5 is used.

In the case of wideband code division multiple access (W-CDMA) system under development by various parties, a relatively high communication speed of a maximum of 2 Mbps and a relatively wide signal bandwidth are required. In order to prevent the bandwidth from becoming large, a relatively small roll-off coefficient of α=0.22 is used.

Since the mobile communication system, the mobile communication method, the base station and the mobile stations according to the related art are constructed as described above, it is necessary to prevent the operation of the power amplifier in the transmit system of the mobile station in a nonlinear region in order to prevent adjacent channel interference caused by nonlinear distortion signal components. As a result, there is a problem in that the efficiency of the power amplifier becomes poor.

The poor efficiency of the power amplifier means a poor efficiency of a battery in a mobile station, which causes the power consumption to increase and reduces the duration available for communication.

A more specific description will now be given of the problem.

FIG. 3 is a graph illustrating the problem as described above. FIG. 3(a) is a graph showing an input-output characteristic of the power amplifier of the mobile station. FIG. 3(b) is a schematic diagram showing communication spectrum occurring in a linear operation of the power amplifier of the mobile station. FIG. 3(c) shows communication spectrum occurring in a nonlinear operation.

A power amplifier such as the power amplifier 105 in the transmit system of the first mobile station MS1 amplifies a data signal to be transmitted from a mobile station and has a limited output power because it uses a battery or the like, provided in the mobile station, as a power source. Typically, the amplifier of this category has an input-output characteristic shown in FIG. 3(a). In FIG. 3(a), an input power Pin is plotted horizontally and an output power Pout is plotted vertically.

Referring to FIG. 3(a), when the input power Pin is small, the input-output characteristic of the power amplifier is regarded as a linear characteristic (linear region). As the input power Pin increases, the rate of increase of the output power Pout decreases so that an output power saturation is exhibited (nonlinear region).

When the power amplifier 105 of the first mobile station MS1 of FIG. 1 is operated at an operating point a in the linear region, the communication spectrum S1-S3 of the first through third mobile stations MS1-MS3 is as schematically shown in FIG. 3(b). In the case of FIG. 3(b), the spectrum S1-S3 in the respective communication channel bands does not interfere with each other so that no problem is caused.

When the power amplifier 105 is operated at an operating point b in the nonlinear region, nonlinear distortion signal components are generated or increased due to the nonlinear operation of the power amplifier 105, resulting in, as shown in FIG. 3(c), the first mobile station MS1 using the communication spectrum S1′. The communication spectrum S1′ in the first communication channel band ΔF1 grows to the second communication spectrum S2 in the second communication channel band ΔF2 and the third communication spectrum S3 in the third communication channel band ΔF3, disturbing communication in the second mobile station MS2 and the third mobile station MS3.

For this reason, the operating region of the power amplifier in the transmit system of the mobile station is designed so as to ensure a large a back-off defining a difference between a maximum output and an operating point in order to reduce the level of nonlinear distortion signal components. As a result, the efficiency of the power amplifier is relatively poor.

In a system like W-CDMA where the roll-off coefficient α is small and fluctuation in an envelope is large, it is particularly important to provide a large back-off. For this reason, the efficiency of the power amplifier becomes even more reduced, reducing the period of time available for communication in the mobile station.

The present invention has been developed with a view to resolving the problem described above and has an objective of establishing a mobile communication system, a mobile communication method, a base station and a mobile station in which adjacent channel interference caused by nonlinear distortion signal components is controlled, and in which it is possible to operate a power amplifier in a transmit system, for amplifying a data signal to be transmitted from a mobile station, in a nonlinear region.

### DISCLOSURE OF THE INVENTION

In accordance with a mobile communication system according to the invention, a base station monitors volumes of communication in communication channel bands adjacent to a given communication channel used in communication with mobile station groups, or monitors a level of interference with the adjacent communication channels from the given communication channel, changes a receive-system band-limiting characteristic in the given communication channel band in accordance with the volumes of communication or the level of interference and transmits information for changing a transmit-system band-limiting characteristic in the mobile station groups communicating in the given communication channel band, and the mobile station groups change the transmit-system band-limiting characteristic in accordance with the information and changes an operating point of a transmit-system power amplifier for amplifying a data signal transmitted to the base station.

With this, the efficiency of a transmit-system power amplifier is improved without generating or increasing interference with the adjacent communication channels due to nonlinear distortion signal components and a period of time available for communication is increased.

In accordance with another mobile communication system according to the invention, the base station monitors volumes of communication in communication channel bands adjacent to a given communication channel used in communication with mobile station groups, or monitors a level of interference with the adjacent communication channels from the given communication channel, changes intervals between frequencies set up for the given communication channel and the adjacent communication channels, in accordance with volumes of communication or the level of interference, and transmits information for changing the intervals to the mobile station groups, the mobile station groups change the intervals in accordance with the information, and the mobile station groups using the given communication channel band change an operating point of a transmit-system power amplifier for amplifying a data signal transmitted to the base station.

With this, the efficiency of a transmit-system power amplifier is improved without generating or increasing interference with the adjacent communication channels due to nonlinear distortion signal components and a period of time available for communication is increased.

In further accordance with the mobile communication system according to the invention, the base station changes the receive-system band-limiting characteristic so as to result in a relatively broad frequency band, when the volume of communication or the level of interference is relatively small, and the mobile station groups change the transmit-system band-limiting characteristic so as to result in a relatively broad frequency band, in accordance with the information transmitted from the base station and changes the operating point of the transmit-system power amplifier so that an operation is steered into a nonlinear region.

With this, the efficiency of a transmit-system power amplifier is improved without generating or increasing interference with the adjacent communication channels due to nonlinear distortion signal components and a period of time available for communication is increased.

In further accordance with the mobile communication system according to the invention, the base station changes the intervals between frequencies set up for the given communication channel and the adjacent communication channels so that the given communication channel band is relatively broad, when the volume of communication or the level of interference is relatively great, and the mobile station groups changes the operating point of the transmit-system power amplifier so that an operation is steered into a nonlinear region.

With this, the efficiency of a transmit-system power amplifier is improved without generating or increasing interference with the adjacent communication channels due to nonlinear distortion signal components and a period of time available for communication is increased.

In further accordance with the mobile communication system according to the invention, the base station monitors the number of communicating mobile stations in the mobile station groups as indicating the volume of communication.

With this, the volume of communication is known in a tangible manner.

In further accordance with the mobile communication system according to the invention, the base station monitors the number of communicating mobile stations in the mobile station groups as indicating the volume of communication.

With this, the volume of communication is known in a tangible manner.

In further accordance with the mobile communication system according to the invention, the base station monitors nonlinear distortion signal components in the data signal grown from the given communication channel band and appearing in outputs from demodulators in the adjacent communication channel bands, as indicating the level of interference.

With this, the level of interference is known in a tangible manner.

In further accordance with the mobile communication system according to the invention, the base station monitors nonlinear distortion signal components in the data signal grown from the given communication channel band and appearing in outputs from demodulators in the adjacent communication channel bands, as indicating the level of interference.

With this, the level of interference is known in a tangible manner.

In accordance with a mobile communication method according to the invention, a base station monitors volumes of communication in communication channel bands adjacent to a given communication channel used in communication with mobile station groups, or monitors a level of interference with the adjacent communication channels from the given communication channel, changes a receive-system band-limiting characteristic in the given communication channel band in accordance with the volumes of communication or the level of interference and transmits information for changing a transmit-system band-limiting characteristic in the mobile station groups communicating in the given communication channel band, and the mobile station groups change the transmit-system band-limiting characteristic in accordance with the information and changes an operating point of a transmit-system power amplifier for amplifying a data signal transmitted to the base station.

With this, the efficiency of a transmit-system power amplifier is improved without generating or increasing interference with the adjacent communication channels due to nonlinear distortion signal components and a period of time available for communication is increased.

In accordance with another mobile communication method according to the invention a base station monitors volumes of communication in communication channel bands adjacent to a given communication channel used in communication with mobile station groups, or monitors a level of interference with the adjacent communication channels from the given communication channel, changes intervals between frequencies set up for the given communication channel and the adjacent communication channels, in accordance with the volumes of communication or the level of interference, and transmits information for changing the intervals to the mobile station groups, the mobile station groups change the intervals in accordance with the information, and the mobile station groups using the given communication channel band change an operating point of a transmit-system power amplifier for amplifying a data signal transmitted to the base station.

With this, the efficiency of a transmit-system power amplifier is improved without generating or increasing interference with the adjacent communication channels due to nonlinear distortion signal components and a period of time available for communication is increased.

In further accordance with the mobile communication method according to the invention, the base station changes the receive-system band-limiting characteristic so as to result in a relatively broad frequency band, when the volume of communication or the level of interference is relatively small, and the mobile station groups change the transmit-system band-limiting characteristic so as to result in a relatively broad frequency band, in accordance with the information transmitted from the base station and changes the operating point of the transmit-system power amplifier so that an operation is steered into a nonlinear region.

With this, the efficiency of a transmit-system power amplifier is improved without generating or increasing interference with the adjacent communication channels due to nonlinear distortion signal components and a period of time available for communication is increased.

In further accordance with the mobile communication method according to the invention, the base station changes the intervals between frequencies set up for the given communication channel and the adjacent communication channels so that the given communication channel band is relatively broad, when the volume of communication or the level of interference is relatively great, and the mobile station groups changes the operating point of the transmit-system power amplifier so that an operation is steered into a nonlinear region.

With this, the efficiency of a transmit-system power amplifier is improved without generating or increasing interference with the adjacent communication channels due to nonlinear distortion signal components and a period of time available for communication is increased.

A base station according to the invention monitors volumes of communication in communication channel bands adjacent to a given communication channel used in communication with mobile station groups, or monitors a level of interference with the adjacent communication channels from the given communication channel, changes a receive-system band-limiting characteristic in the given communication channel band in accordance with the volumes of communication or the level of interference and transmits information for changing a transmit-system band-limiting characteristic in the mobile station groups communicating in the given communication channel band.

With this, the efficiency of a transmit-system power amplifier is improved without generating or increasing interference with the adjacent communication channels due to nonlinear distortion signal components and a period of time available for communication is increased.

Another base station according to the invention monitors volumes of communication in communication channel bands adjacent to a given communication channel used in communication with mobile station groups, or monitors a level of interference with the adjacent communication channels from the given communication channel, changes intervals between frequencies set up for the given communication channel and the adjacent communication channels, in accordance with the volumes of communication or the level of interference, and transmits information for changing the intervals to the mobile station groups.

With this, the efficiency of a transmit-system power amplifier is improved without generating or increasing interference with the adjacent communication channels due to nonlinear distortion signal components and a period of time available for communication is increased.

The base station according to the invention changes the receive-system band-limiting characteristic so as to result in a relatively broad frequency band, when the volume of communication or the level of interference is relatively small.

With this, the efficiency of a transmit-system power amplifier is improved without generating or increasing interference with the adjacent communication channels due to nonlinear distortion signal components and a period of time available for communication is increased.

The base station according to the invention changes the intervals between frequencies set up for the given communication channel and the adjacent communication channels so that the given communication channel band is relatively broad, when the volume of communication or the level of interference is relatively great.

With this, the efficiency of a transmit-system power amplifier is improved without generating or increasing interference with the adjacent communication channels due to nonlinear distortion signal components and a period of time available for communication is increased.

A mobile station according to the invention changes a transmit-system band-limiting characteristic in accordance with information transmitted by a base station to change the band-limiting characteristic of mobile station groups communicating in a given communication channel band and changing an operating point of a transmit-system power amplifier for amplifying a data signal transmitted to the base station

With this, the efficiency of a transmit-system power amplifier is improved without generating or increasing interference with the adjacent communication channels due to nonlinear distortion signal components and a period of time available for communication is increased.

Another mobile station according to the invention changes intervals between frequencies set up for the communication channel bands, in accordance with information transmitted from a base station to change the intervals, and, when the mobile station constitutes a mobile station group communicating in a given communication channel with the base station, changes an operating point of a transmit-system power amplifier for amplifying a data signal transmitted to the base station.

With this, the efficiency of a transmit-system power amplifier is improved without generating or increasing interference with the adjacent communication channels due to nonlinear distortion signal components and a period of time available for communication is increased.

The mobile station according to the invention changes the transmit-system band-limiting characteristic so as to result in a relatively broad frequency band, in accordance with information transmitted from the base station, and changing the operating point of the transmit-system power amplifier so that an operation is steered into a nonlinear region.

With this, the efficiency of a transmit-system power amplifier is improved without generating or increasing interference with the adjacent communication channels due to nonlinear distortion signal components and a period of time available for communication is increased.

The mobile station according to the invention changes the operating point of the transmit-system power amplifier so that an operation is steered into a nonlinear region, when the mobile station constitutes a mobile station group communicating in the given communication channel band.

With this, the efficiency of a transmit-system power amplifier is improved without generating or increasing interference with the adjacent communication channels due to nonlinear distortion signal components and a period of time available for communication is increased.

### BRIEF DESCRIPTION OF THE DRAWINGS

FIG. 1 shows a construction of a mobile communication system according to the related art.

FIG. 2 is a graph showing a Nyquist filter characteristic.

FIG. 3 is a graph illustrating a problem according to the related art.

FIG. 4 shows a construction of a mobile communication system according to a first embodiment of the present invention.

FIG. 5 is a graph illustrating a communication operation of the mobile communication system according to the first embodiment.

FIG. 6 shows a construction of a mobile communication system according to a second embodiment of the present invention.

FIG. 7 shows a construction of a mobile communication system according to a third embodiment of the present invention.

FIG. 8 is a graph illustrating an operation of the mobile communication system according to the third embodiment.

### BEST MODE OF CARRYING OUT THE INVENTION

A detailed description of the invention will now be given by describing the best mode of carrying out the invention with reference to the attached drawings.

First Embodiment

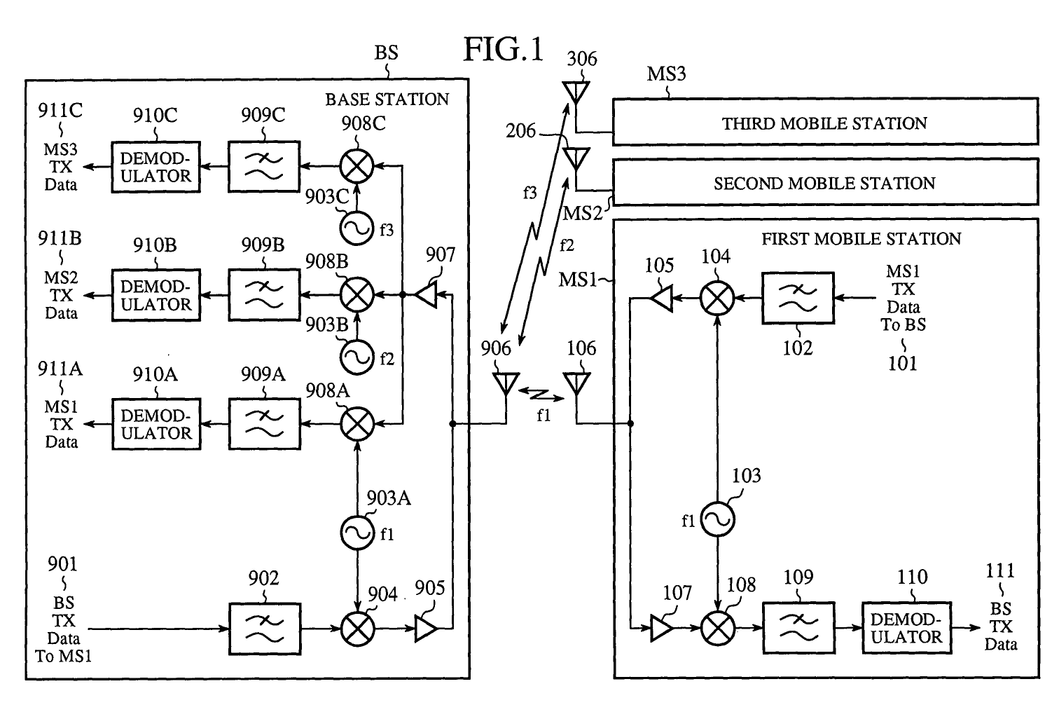

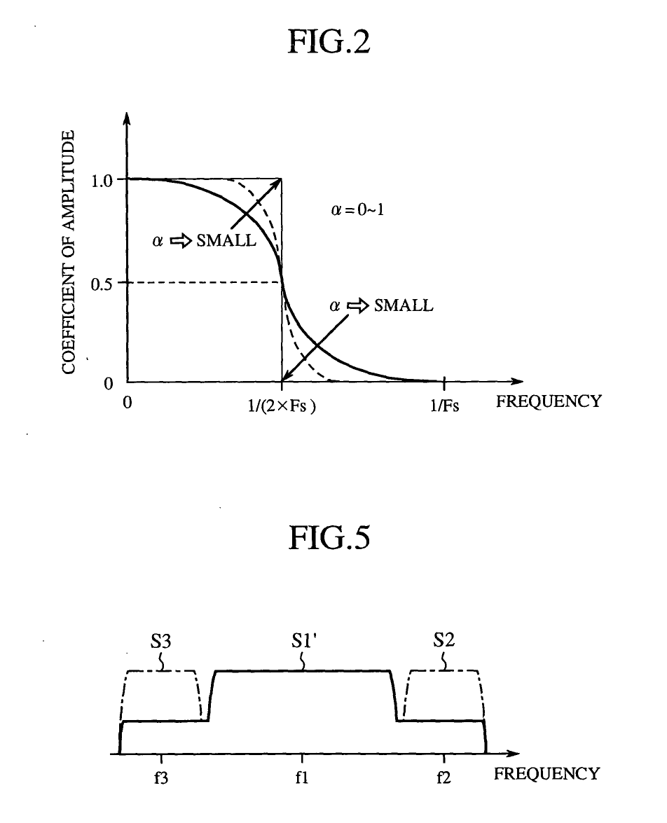

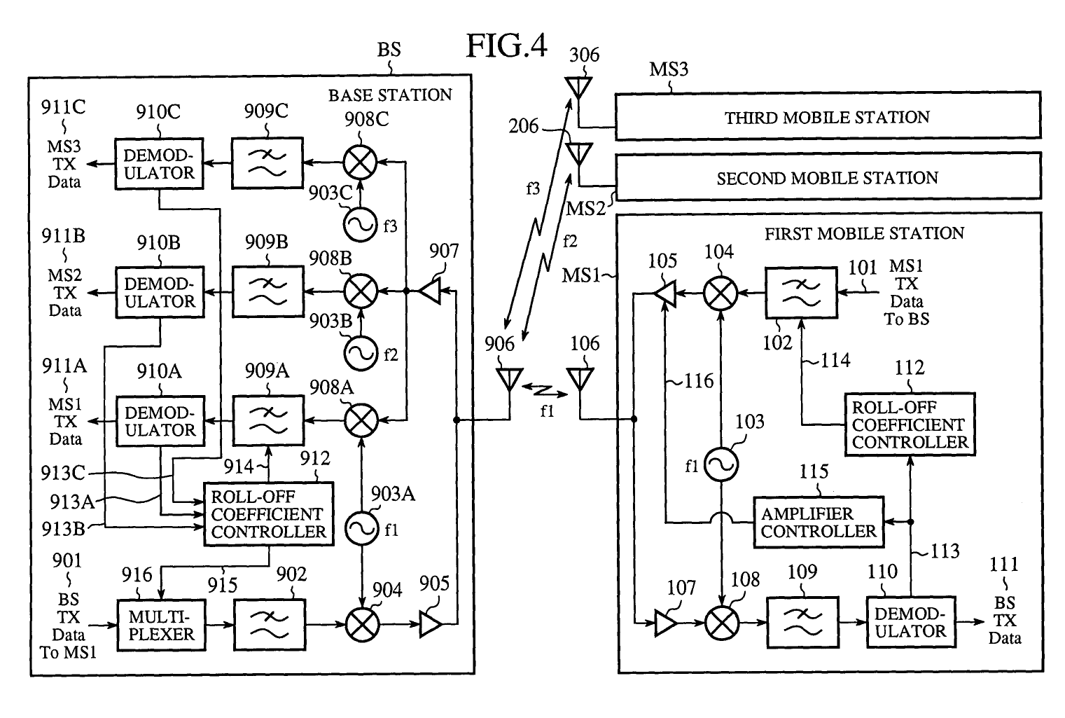

FIG. 4 shows a construction of a mobile communication system according to a first embodiment of the present invention. In FIG. 4, a circuit block of a base station (stationary station) and circuit blocks of three mobile stations are shown. In FIGS. 1 and 4, those components designated by the same reference numerals have the same construction or similar constructions.

In the base station BS of FIG. 4, reference numeral 912 indicates a roll-off coefficient controller, 913A, 913B and 913C indicate volumes of communication indicating demodulated outputs in the communication channel bands ΔF1, ΔF2 and ΔF3, 914 indicates a roll-off coefficient control signal, 915 indicates a roll-off coefficient notification data signal (symbol) transmitted to the first mobile station MS1, 916 indicates a multiplexer for multiplexing the data signal 901 and the roll-off coefficient notification signal 915.

In the mobile station MS1 of FIG. 4, reference numeral 112 indicates a roll-off coefficient controller, 113 indicates a roll-off coefficient notification data signal transmitted from the base station BS, 114 indicates a roll-off coefficient control signal, 115 indicates an amplifier controller and 116 indicates an amplifier control signal.

A description will now be given of the operation according to the first embodiment.

The roll-off coefficient controller 912 monitors the volumes of communication 913A-913C in the communication channel bands ΔF1, ΔF2 and ΔF3 output from the demodulators 910A-910C. When the volume of communication 913A with the first mobile station MS1 is determined, the roll-off coefficient controller 912 examines the volumes of communication 913B and 913C in the second and third communication channel bands (adjacent communication channel bands) ΔF2 and ΔF3, respectively, adjacent to the first communication channel band (given communication channel band) ΔF1. The roll-off coefficient controller 912 uses the roll-off coefficient control signal 914 to change the roll-off coefficient α of the root Nyquist filter 909A in the receive system used in communication with the first mobile station MS1, in accordance with the examined volumes of communication.

For example, when the volumes of communication in the second and third communication channel bands ΔF2 and ΔF3 are both 0 (when there is no communication), the roll-off coefficient controller 912 increases the roll-off coefficient α of the root Nyquist filter 909A using the roll-off control signal 914. Since the roll-off coefficient α of the root Nyquist filter 909A is increased, the band-limiting characteristic in the receive system is changed.

In order to change the roll-off coefficient α of the root Nyquist filter 102 in the transmit system of the first mobile station MS1, the roll-off coefficient controller 912 outputs the roll-off coefficient notification data signal 915 indicating the changed roll-off coefficient α to the multiplexer 916 for multiplexing with the data signal 901. The roll-off coefficient notification data signal 915 multiplexed with the data signal 901 is transmitted by radio from the transmission/reception antenna 906 via the root Nyquist filter 902, the frequency converter 904 and the power amplifier 905 to the first mobile station MS1. The transmitted signal is used as information to change the band-limiting characteristic in the transmit system of the first mobile station MS1.

The first mobile station MS1 receives the data signal 901 and the roll-off coefficient notification data signal 915 as a multiplexed signal at the transmission/reception antenna 106. The multiplexed signal is transferred to the low noise amplifier 107, the frequency converter 108, the root Nyquist filter 109 and the demodulator 110. The demodulator 110 isolates the roll-off coefficient notification data signal 915 from the data signal 901. The isolated signal is supplied as the roll-off coefficient notification data signal 113 to the roll-off coefficient controller 112 and the amplifier controller 115.

The roll-off coefficient controller 112 outputs the roll-off coefficient control signal 114 to the root Nyquist filter 102 in the transmit system to cause it to operate at the roll-off coefficient α indicated by the roll-off coefficient notification data signal 113. The roll-off coefficient α of the root Nyquist filter 102 is changed to a value designated by the roll-off coefficient control signal 114 so that the filter band-limiting characteristic in the transmit system is changed accordingly. The amplifier controller 115 outputs the amplifier control signal 116 to the power amplifier 105 in accordance with the roll-off coefficient notification data signal 113. The power amplifier 105 controls the operating point of the amplifier to be located in a nonlinear region in accordance with the amplifier control signal 116.

The data signal 101 from the first mobile station MS1 is transmitted to the base station BS via the root Nyquist filter 102 in the transmit system having its roll-off coefficient α changed, the frequency converter 104, the power amplifier 105 in a nonlinear operation and the transmission/reception antenna 106. The data signal 101 is supplied to the root Nyquist filter 909A in the receive system having its roll-off coefficient α changed, via the transmission/reception antenna 906, the low noise amplifier 907, the frequency converter 908A of the base station BS. The data signal 101 is then demodulated by the demodulator 910A to produce the data signal 911A.

In a case as described above, where the volumes of communication in the second and third communication channel bands ΔF2 and ΔF3 is 0 so that adjacent channel interference is not caused even when the power amplifier 105 in the transmit system of the first mobile station MS1 is operated in a nonlinear region. Accordingly, the efficiency of the power amplifier 105 is raised. Power consumption in the mobile station MS1 is reduced so that the period of time available for communication is increased.

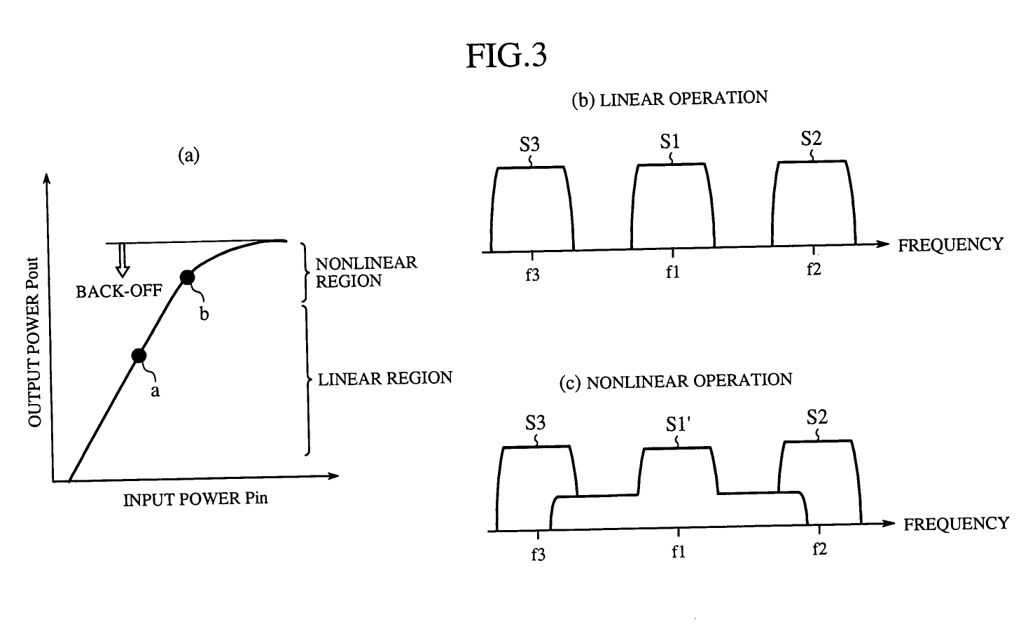

FIG. 5 is a graph illustrating the communication operation of the mobile communication system according to the first embodiment and corresponds to FIG. 3 referred to in the description of the related art. Referring to FIG. 5, the first mobile station MS1 communicates with the base station BS in the first communication channel band ΔF1 with the center frequency f1 (communication spectrum S1′). No communication is performed in the second communication channel band ΔF2 with the center frequency f2 (communication spectrum S2) and in the third communication channel band ΔF3 with the center frequency f3 (communication spectrum S3).

As described above, by increasing the roll-off coefficient α of the root Nyquist filter 102 in the transmit system of the first mobile station MS1, the communication spectrum S1′ of the first mobile station MS1 grows so that nonlinear distortion signal components are extended to a broad frequency band transmitted. However, since there is no communication occurring in the second and third communication channel bands ΔF2 and ΔF3, no interference is caused in the second and third communication channel bands ΔF2 and ΔF3.

By increasing the roll-off coefficient α, less amplitude fluctuation results. As a result of this, the required depth of back-off is reduced. An advantage according to the first embodiment is that the required depth of back-off is further reduced by viewing the volume of communication in the adjacent channels as being 0. Since it is possible to extend the operation of the power amplifier 105 further into a nonlinear region, the power consumption in the first mobile station MS1 is reduced so that the period of time available for communication is increased.

In the description above, it is assumed that no communication occurs in the second and third communication channel bands ΔF2 and ΔF3. The first embodiment is equally applicable to a situation other than this. The roll-off coefficient α of the root Nyquist filters 909A and 102 may be changed depending on the volumes of communication in the second and third communication channel bands ΔF2 and ΔF3 to produce a similar advantageous result.

In the description above, the roll-off coefficient notification data signal 915 is transmitted from the base station BS to the first mobile station MS1 so that the first mobile station MS1 is allowed to change the band-limiting characteristic in the transmit system of the first mobile station MS1 accordingly. The same operation may also be performed without the roll-off coefficient notification data signal 915. As will be appreciated in the second embodiment described below, a requirement to provide the same advantageous result is that some information be transmitted in order to change the band-limiting characteristic in the transmit system of the mobile station.

The target of monitoring by the roll-off coefficient controller 912 may not be the volumes of communication in the second and third communication channel bands ΔF2 and ΔF3. The level of interference with the second and third communication channel bands ΔF2 and ΔF3 from the first communication channel band ΔF1 may be measured by observing nonlinear distortion signal components grown from the first communication channel band ΔF1 and appearing in demodulated outputs of the demodulators 910B and 910C.

In other words, instead of monitoring the volumes of communication 913A-913C, nonlinear distortion signal components appearing in the outputs of the demodulators 910B and 910C may be supplied to the roll-off coefficient controller 912 for monitoring. The roll-off coefficient α of the root Nyquist filter 909A and the roll-off coefficient α of the root Nyquist filter 102 may then be changed depending on the magnitude of nonlinear distortion signal components that causes interference. In this way, the same advantageous result as described above is achieved.

Alternatively, monitoring may not be concerned with the volume of communication or the level of interference. In a configuration where each of the mobile stations MS1, MS2 and MS3 is actually a mobile station group comprising a plurality of individual mobile stations, the number of individual mobile stations in the mobile station groups MS1, MS2 and MS3 that are engaged in communication may be monitored by the base station BS as indicating the volume of communication in the corresponding one of the communication channel bands ΔF1, ΔF2 and ΔF3.

Thus, according to the first embodiment, the base station BS is configured to monitor the volumes of communication 913B and 913C or the level of interference in the second and third communication channel bands ΔF2 and ΔF3 adjacent to the first communication channel band ΔF1, so as to change the receive-system band-limiting characteristic in the first communication channel band ΔF1 in accordance with the volumes of communication 913B and 913C or the level of interference, and to notify the first mobile station MS1 communicating using the first communication channel band ΔF1 of the changed receive-system band-limiting characteristic (rolloff coefficient α). The first mobile station MS1 is configured to change the transmit-system band-limiting characteristic in accordance with the changed receive-system band-limiting characteristic, and to modify the operation of the transmit-system power amplifier 105 for amplifying the data signal 101 to be transmitted from the first mobile station. Accordingly, the efficiency of the transmit-system power amplifier 105 is improved without generating or increasing interference with the second and third communication channel bands ΔF2 and ΔF3 due to nonlinear distortion, and the period of time available for communication in the first mobile station MS1 is increased.

In further accordance with the first embodiment, when each of the mobile stations MS1, MS2 and MS3 is actually a mobile station group comprising a plurality of individual mobile stations, the base station BS may monitor the number of individual mobile stations communicating in the mobile station groups MS1, MS2 and MS3 as indicating the corresponding volume of communication. Therefore, the volumes of communication are known in a tangible manner.

In still further accordance with the first embodiment, the base station BS may monitor the nonlinear distortion signal components grown from the first communication channel band ΔF1 and appearing in the data signals 911B and 911C in the second and third communication channel bands ΔF2 and ΔF3 output from the respective demodulators, as indicating the level of interference. Accordingly, the level of interference is known in a tangible manner.

Second Embodiment

In the first embodiment, the roll-off coefficient α of the root Nyquist filters 909A and 102 is changed. Alternatively, the band-limiting characteristic of the root Nyquist filters 909A and 102 may be changed by changing a ratio (referred to as an allocation factor) in which the transfer function is shared between the filters, resulting in a deviation from the square-root sharing of the transfer characteristic between the filters.

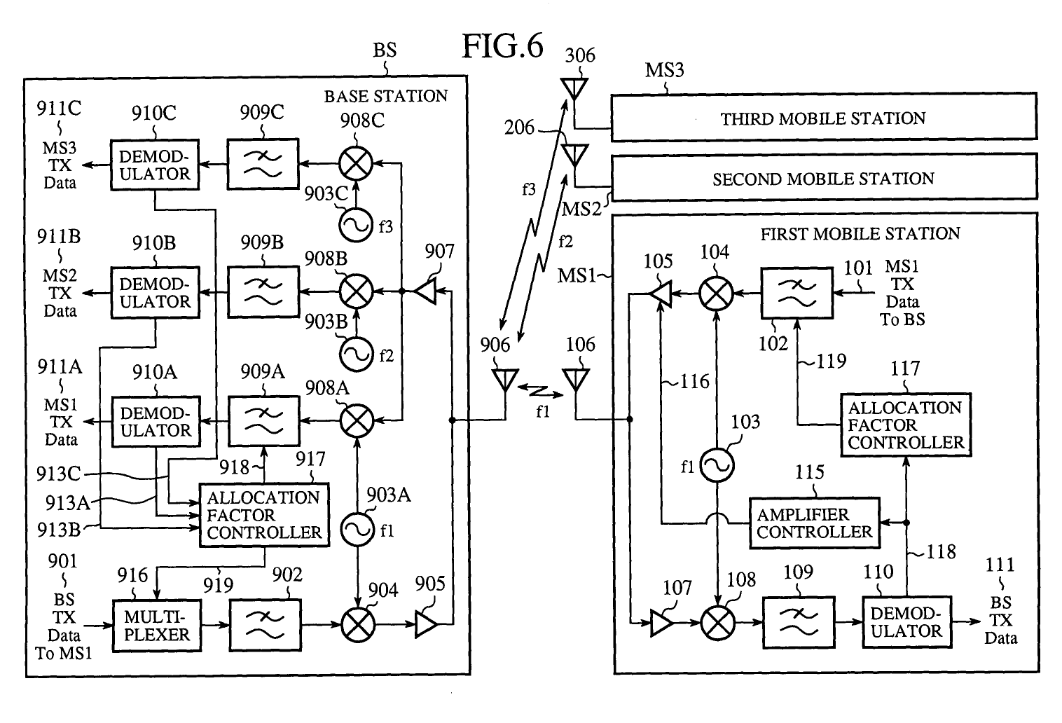

FIG. 6 shows a construction of a mobile communication system according to the second embodiment. Those components that are identical with or corresponding to the components of FIGS. 1 and 4 are designated by the same reference numerals.

In the base station BS of FIG. 6, reference numeral 917 indicates an allocation factor controller, 918 indicates an allocation factor control signal and 919 indicates an allocation factor notification data signal (symbol) transmitted to the first mobile station MS1.

In the first mobile station MS1 of FIG. 6, reference numeral 117 indicates an allocation factor controller, 118 indicates an allocation factor notification data signal (symbol) transmitted from the base station BS and 119 indicates an allocation factor control signal.

A description will now be given of the operation according to the second embodiment.

The allocation factor controller 917 of the base station BS monitors the volumes of communication 913A-913C in the respective communication channel bands ΔF1-ΔF3 output from the demodulators 910A-910C, respectively. When the volume of communication 913A with the first mobile station MS1 is determined, the allocation factor controller 917 examines the volumes of communication 913B and 913C in the second and third communication channel bands ΔF2 and ΔF3, respectively, adjacent to the first communication channel band ΔF1. The allocation factor controller 917 uses the allocation factor control signal 918 to change the share of transfer function allocated to the root Nyquist filter 909A in the receive system used in communication with the first mobile station MS1, in accordance with the examined volumes of communication.

For example, when the volumes of communication in the second and third communication channel bands ΔF2 and ΔF3 are both 0, the allocation factor controller 917 increases the share of transfer function allocated to the root Nyquist filter 909A using the allocation factor control signal 918. Since the share of transfer function allocated to the root Nyquist filter 909A is increased, the band-limiting characteristic in the receive system is changed accordingly.

In order to change the share of transfer function allocated to the root Nyquist filter 102 in the transmit system of the first mobile station MS1, the allocation factor controller 917 outputs the allocation factor notification data signal 918 indicating the changed allocation factor to the multiplexer 916 for multiplexing with the data signal 901. The allocation factor notification data signal 918 multiplexed with the data signal 901 is transmitted by radio from the transmission/reception antenna 906 to the first mobile station MS1 via the root Nyquist filter 902, the frequency converter 904 and the power amplifier 905 in the transmit system. The transmitted signal is used as information to change the band-limiting characteristic in the transmit system of the first mobile station MS1.

The first mobile station MS1 receives the data signal 901 and the allocation factor notification data signal 918 as a multiplexed signal via the transmission/reception antenna 106. The multiplexed signal is supplied to the demodulator 110 via the low noise amplifier 107, the frequency converter 108 and the root Nyquist filter 109. The demodulator 110 isolates the allocation factor notification data signal 918 from the data signal 901. The isolated signal is supplied as the allocation factor notification data signal 118 to the allocation factor controller 117 and the amplifier controller 115.

The allocation factor controller 117 outputs the allocation factor control signal 119 to the root Nyquist filter 102 in the transmit system to cause it to operate at the allocation factor indicated by the allocation factor notification data signal 118. The allocation factor of the root Nyquist filter 102 is changed to a value designated by the allocation factor control signal 119 so that the filter band-limiting characteristic in the transmit system is changed accordingly. The amplifier controller 115 outputs the amplifier control signal 116 to the power amplifier 105 in accordance with the allocation factor notification data signal 118. The power amplifier 105 controls the operating point of the amplifier to be located in a nonlinear region in accordance with the amplifier control signal 116.

The data signal 101 from the first mobile station MS1 is transmitted to the base station BS via the root Nyquist filter 102 having its allocation factor (share of transfer characteristic) changed, the frequency converter 104, the power amplifier 105 in a nonlinear operation and the transmission/reception antenna 106 in the transmit system. The data signal 101 is supplied to the root Nyquist filter 909A in the receive system having its allocation factor (share of transfer characteristic) changed, via the transmission/reception antenna 906, the low noise amplifier 907, the frequency converter 908A of the base station BS. The data signal 101 is then demodulated by the demodulator 910A to produce the data signal 911A.

Thus, by altering the square root (√) sharing of the transfer characteristic between the root Nyquist filters 102 in the transmit system of the first mobile station MS1 and the root Nyquist filter 909A in the receive system of the base station BS, the band-limiting characteristic and the envelope fluctuation are changed accordingly so that it is possible to operate the power amplifier 105 in a nonlinear region. Thereby, the same advantageous result as provided by the first embodiment is available in the second embodiment.

In changing the allocation factor, it is ensured, as in the square root sharing, that the product of transfer characteristic in the transmit system and that of the receive system is the Nyquist filter characteristic. For example, when the share of the mobile station MS is raised from 0.5 (square root) to 1, the share of the base station BS is lowered from 0.5 to 0.

In the foregoing description, it is assumed that the volumes of communication in the second and third communication channel bands ΔF2 and ΔF3 are 0. However, the second embodiment is also applicable to other situations. As described in the first embodiment, the same advantageous result according to the invention is provided by changing the allocation factor applied to the root Nyquist filters 909A and 102 in accordance with the volumes of communication in the second and third communication channel bands ΔF2 and ΔF3.

The target of monitoring by the allocation factor controller 917 is not limited to the volumes of communication in the second and third communication channel bands ΔF2 and ΔF3. As described in the first embodiment, the allocation factor may be changed in accordance with nonlinear distortion signal components grown from the first communication channel band ΔF1 and appearing in the outputs from the modulators 910B and 910C.

Alternatively, monitoring may not be concerned with the volume of communication or the level of interference. In a configuration where each of the mobile stations MS1, MS2 and MS3 is actually a mobile station group comprising a plurality of individual mobile stations, the number of individual mobile stations in the mobile station groups MS1, MS2 and MS3 that are engaged in communication may be monitored by the base station BS as indicating the volume of communication in the corresponding one of the communication channel bands ΔF1, ΔF2 and ΔF3.

Third Embodiment

In the third embodiment, a description will be given of a method in which the carrier frequencies f1-f3 are changed instead of the band-limiting characteristic of the root Nyquist filters 102 and 909A, which is changed according to the first and second embodiments.

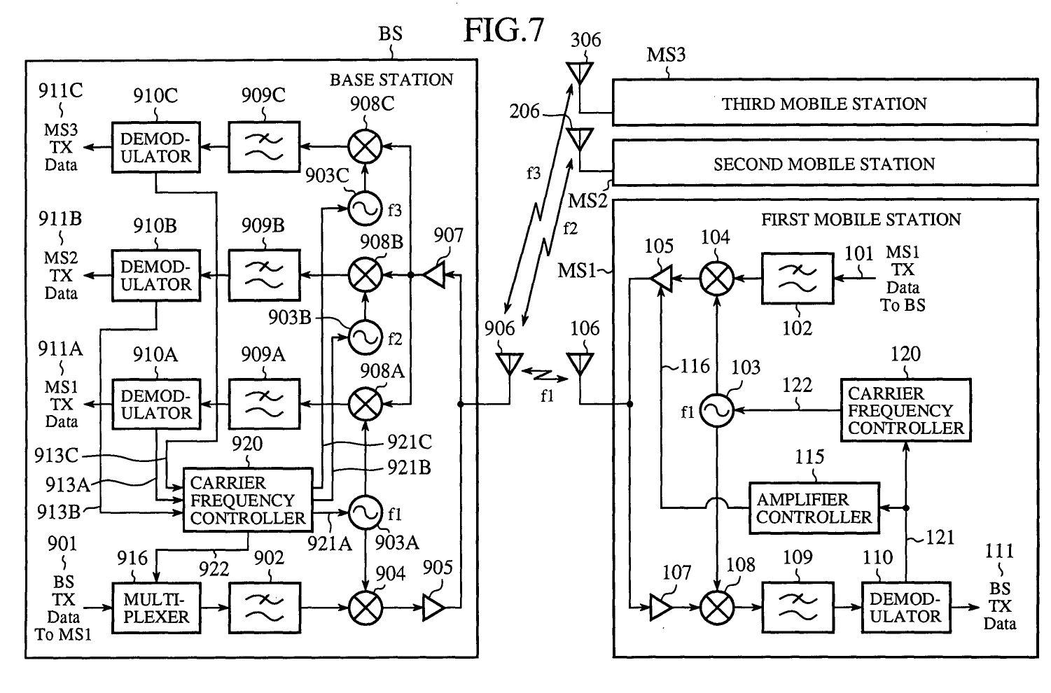

FIG. 7 shows a construction of a mobile communication system according to the third embodiment. Those components that are identical with or corresponding to the components of FIGS. 1 and 4 are designated by the same reference numerals.

In the base station BS of FIG. 7, reference numeral 920 indicates a carrier frequency controller, 921A, 921B and 921C indicate carrier frequency control signals and 922 indicates a carrier frequency notification data signal (symbol) transmitted to the first mobile station MS.

In the first mobile station MS1 of FIG. 7, reference numeral 120 indicates a carrier frequency controller, 121 indicates a carrier frequency notification data signal (symbol) transmitted from the base station BS and 122 indicates a carrier frequency control signal.

In the third embodiment, the carrier frequencies f1-f3 of the carrier oscillators 908A-908C and the carrier frequency f1 of the carrier oscillator 103 of the first mobile station MS1 are changed in accordance with the carrier frequency control signals 921A-921C and the carrier frequency control signal 122, respectively. The carrier frequencies f2 and f3 of the second mobile station MS2 and the third mobile station MS3, respectively, may also be changed in a similar configuration.

A description will now be given of the operation according to the third embodiment.

The carrier frequency controller 920 of the base station BS monitors the volumes of communication 913A-913C in the respective communication channel bands ΔF1-ΔF3 determined based on outputs from the demodulators 910A-910C, respectively. When the volume of communication 913A with the first mobile station MS1 is determined, the carrier frequency controller 920 examines the volumes of communication 913B and 913C in the second and third communication channel bands ΔF2 and ΔF3, respectively, adjacent to the first communication channel band ΔF1. The carrier frequency controller 920 changes the carrier frequencies f1-f3 of the carrier oscillators 908A-908C, in accordance with the examined volumes of communication.

For example, when the volumes of communication in the second and third communication channel bands ΔF2 and ΔF3 are large, the carrier frequency controller 920 outputs the carrier frequency control signals 921A-921C to the carrier oscillators 908A-908C, respectively, so as to increase intervals between the carrier frequencies f1-f3. For the purpose of discussion, it is assumed that the carrier frequency f1 remains unchanged, the carrier frequency f2 is controlled to be lower and the carrier frequency f3 is controlled to be higher.

Simultaneously, the carrier frequency controller 920 outputs the carrier frequency notification data signal 922 indicating the carrier frequency f1 to the multiplexer 916 for multiplexing with the data signal 901 so as to notify the first mobile station MS1 of the carrier frequency f1 subjected to the control (in this case. unmodified). The multiplexed signal is transmitted by radio from the transmission/reception antenna 906 via the root Nyquist filter 902, the frequency converter 904 and the power amplifier 905, as information for modifying the interval between the frequencies set up for the respective communication channel bands.

The second and third mobile stations MS2 and MS3 are also notified of the carrier frequencies f2 and f3 (modified values) in a similar operation.

The first mobile station MS1 receives the data signal 901 and the carrier frequency notification data signal 922 as a multiplexed signal via the transmission/reception antenna 106. The multiplexed signal is supplied to the demodulator 110 via the low noise amplifier 107, the frequency converter 108 and the root Nyquist filter 109. The demodulator 110 isolates the carrier frequency notification data signal 922 from the data signal 901. The isolated signal is supplied as the carrier frequency notification data signal 121 to the carrier frequency controller 120 and the amplifier controller 115.

The carrier frequency controller 120 outputs the carrier frequency control signal 122 to the carrier oscillator 103 to cause it to produce the carrier frequency f1 indicated by the carrier frequency notification data signal 121. The carrier frequency f1 of the carrier oscillator 103 is controlled in accordance with the carrier frequency control signal 122 (as mentioned above, the carrier frequency f1 remains unchanged in this case).

In a similar operation, the carrier frequencies f2 and f3 of the second and third mobile stations MS2 and MS3 are changed simultaneously so that the intervals f1-f2 and f3-f1 between the center frequencies in the respective channel bands ΔF1-ΔF3 are changed accordingly. The amplifier controller 115 outputs the amplifier control signal 116 to the power amplifier 105 in accordance with the carrier frequency notification data signal 121. The power amplifier 105 controls the operating point of the amplifier to be located in a nonlinear region in accordance with the amplifier control signal 116.

The data signal 101 from the first mobile station MS1 is made to pass through the root Nyquist filter 102 before being mixed in the frequency converter 104 with the output of the carrier oscillator 103 having the carrier frequency f1. The mixed signal is transmitted to the base station BS via the power amplifier 105 and the transmission/reception antenna 106. The data signal is mixed in the frequency converter 908A with the output of the carrier oscillator 103 having the carrier frequency f1 after passing through the transmission/reception antenna 906 and the low noise amplifier 907 of the base station BS. The data signal 101 is then supplied via the root Nyquist filter 909A in the receive system to the demodulator 910A to produce the data signal 911A.

Thus, the intervals between the center frequencies are changed by changing the center frequencies f2 and f3 of the second and third communication channel bands ΔF2 and ΔF3, respectively, adjacent to the first communication channel band ΔF1. In this way, interference with the second and third communication channel bands ΔF2 and ΔF3 caused by nonlinear distortion signal components generated or increased as a result of a nonlinear operation of the power amplifier 105 is suppressed. Accordingly, it is possible to steer the operation of the power amplifier 105 into a nonlinear region.

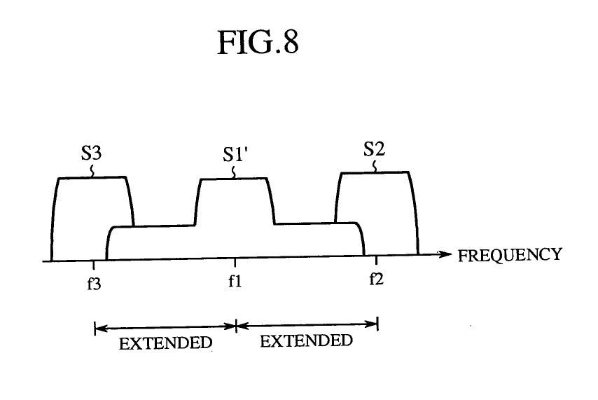

FIG. 8 is a graph illustrating an operation of the mobile communication system according to the third embodiment.

As shown in FIG. 8, by extending the intervals f1-f3 and f2-f1 between the center frequencies in the respective communication channel bands ΔF1-ΔF3, the level of interference with the communication spectrum S2 and S3 in the second and third communication channels ΔF2 and ΔF3, occurring when the nonlinear distortion signal components grown from the communication spectrum S1′ in the first mobile station MS1 are generated or increased, are decreased.

The power amplifier 105 of the first mobile station MS1 may be operated in a nonlinear region until the level of interference with the second and third communication channel bands ΔF2 and ΔF3 is equal to the level before the frequency intervals f1-f3 and f2-f1 are changed. Therefore, the power consumption is reduced and the period of time available for communication is increased.

In the foregoing description, it is assumed that the carrier frequency notification data signal 121 is used to notify the mobile stations of the target carrier frequency so as to change the intervals between frequencies set up for the respective communication channel bands. Alternatively, a set of carrier frequencies used in a given channel band and adjacent channel bands may be designated, or a frequency interval between a carrier frequency and adjacent channel bands may be designated. Any information capable of changing the intervals of frequencies set up for the respective communication channels may be used in the third embodiment.

Thus, according to the third embodiment, the base station BS monitors the volumes of communication 913B and 913C in the second and third communication channel bands ΔF2 and ΔF3, respectively, adjacent to the first communication channel band ΔF1 or monitors the level of interference. The base station BS extends the frequency intervals f1-f2 and f3-f1 between center frequencies by changing the center frequencies f1, f2 and f3 of the first communication channel band ΔF1, the second communication channel band ΔF2 and the third communication channel band ΔF3, respectively, in accordance with the volumes of communication 913B and 913C or in accordance with the level of interference. The base station BS notifies the first mobile station MS1 communicating in the first communication channel band ΔF1 and the second and third mobile stations MS2 and MS3 communicating in the second and third communication channel bands ΔF2 and ΔF3, respectively, of the respective center frequencies f1, f2 and f3 after the change. Accordingly, the mobile stations MS1-MS3 changes its center frequencies f1-f3, respectively. The first mobile station MS1, communicating in the first communication channel band ΔF1, changes the operating point of the power amplifier 105 in the transmit system for amplifying the data signal 101 transmitted to the base station BS. Accordingly, the efficiency of the power amplifier 105 in the transmit system is improved without generating or increasing the nonlinear distortion signal components affecting the second and third communication channel bands ΔF2 and ΔF3 so that the period of time available for communication in the first mobile station MS1 is increased.

In the first and second embodiments, a description is given of a case where three communication channel bands are available for use in a given communication scheme. The volume of communication (or the level of interference) in the adjacent communication channel bands used in different communication schemes may also be target of monitoring. The embodiments may also be advantageously applied where the receive system in the base station BS is capable of receiving signals in different communication schemes.

As illustrated in FIG. 8, according to the third embodiment, the frequency intervals f1-f3 and f2-f1 are changed while the center frequency f1 in the first communication channel band ΔF1 remains unchanged when the second and third communication channel bands ΔF2 and ΔF3 are located on respective sides of the first communication channel band ΔF1. When only the second communication channel band ΔF2 (or ΔF3) located on one of the sides is used in the same communication scheme as the first communication channel band ΔF1, only the center frequency interval f2-f1 (or f1-f3) with respect to the second communication channel band ΔF2 (or ΔF3) used in the same communication scheme may be changed, whereupon, additionally, the carrier frequencies f2 and f1 (or f1 and f3) may be changed, resulting in the center frequency intervals with respect to the third communication channel band ΔF3 (ΔF2) used in a different communication scheme being changed. With this, the same advantageous result is obtained.

In the first through third embodiments, it is assumed that a Nyquist filter is used as a band-limiting filter. The same advantageous result is provided using filters having other band-limiting characteristic such as Gaussian filters.

In the first through third embodiments, the filters are operated in a data signal band (base band) to obtain a band-limiting performance. The band-limiting filtering may be effected on signals having a carrier frequency. Alternatively, a data signal may be converted to a signal in an intermediate frequency band for filtering so that the filtered signal is converted into a radio frequency signal. With this, the same advantageous result is provided.

In the third embodiment, a description is given of time-dependent change in the center frequency intervals with respect to adjacent communication channel bands in accordance with the volumes of communication (or the level of interference) in the adjacent communication channel bands. Alternatively, when a difference in the volumes of communication is expected in the form of, for example, a statistical difference between the volume of communication in an urban area and that of a rural area, the center frequency interval for the urban area may be configured to be different from that of the rural area when the base stations are initially installed. With this, the same advantageous result is provided.

As described in the first and second embodiments, the target of monitoring by the allocation factor controller 917 may not be limited to the volumes of communication in the second and third communication channel bands ΔF2 and ΔF3. The center frequency interval may also be changed in accordance with nonlinear distortion signal components grown from the first communication channel band ΔF1 and appearing in the outputs from the demodulators 910B and 910C.

The description above of the first and second embodiments focuses on the communication between the first mobile station MS1 and the base station BS using the first communication channel band ΔF1. The control of receive-system band-limiting characteristic in the base station is effected only on the band-limiting root Nyquist filter 909A. Alternatively, the same monitoring may be effected on the entirety of communication channel bands so that the band-limiting characteristic in the entirety of bands is subject to control.

In the first through third embodiments, information for determining the transmit-system band-limiting characteristic and information for changing the intervals between frequencies set up for the respective communication channel bands are multiplexed by the multiplexer 916 before transmission from the base station to the mobile station. However, the information may also be transmitted by other means.

In the first through third embodiments, the operating point of the power amplifier 105 is changed by the amplifier controller 115. However, the operating point may also be controlled by other means.

Moreover, the mobile stations (mobile station groups) covered by one base station and communication channel bands used are not limited in number.

### INDUSTRIAL APPLICABILITY

As described above, the mobile communication system, the mobile communication method, the base station and the mobile stations according to the invention are suitable for a W-CDMA system that requires a small roll-off coefficient, and more particularly, to a system in which power consumption in mobile stations is reduced so that a period of time available for communication is increased.

1. A mobile communication system comprising:
a plurality mobile station groups each comprising at least one mobile station; and
a base station communicating with said mobile station groups using a plurality of communication channel bands, wherein
said base station monitors volumes of communication in communication channel bands adjacent to a given communication channel used in communication with said mobile station groups, or monitors a level of interference with said adjacent communication channels from said given communication channel, changes a receive-system band-limiting characteristic in said given communication channel band in accordance with the volumes of communication or the level of interference and transmits information for changing a transmit-system band-limiting characteristic in said mobile station groups communicating in said given communication channel band, and
said mobile station groups change the transmit-system band-limiting characteristic in accordance with the information and changes an operating point of a transmit-system power amplifier for amplifying a data signal transmitted to said base station.

2. A mobile communication system comprising:
a plurality mobile station groups each comprising at least one mobile station; and
a base station communicating with said mobile station groups using a plurality of communication channel bands, wherein
said base station monitors volumes of communication in communication channel bands adjacent to a given communication channel used in communication with said mobile station groups, or monitors a level of interference with said adjacent communication channels from said given communication channel, changes intervals between frequencies set up for said given communication channel and said adjacent communication channels, in accordance with volumes of communication or the level of interference, and transmits information for changing the intervals to said mobile station groups,
said mobile station groups change the intervals in accordance with the information, and
said mobile station groups using said given communication channel band change an operating point of a transmit-system power amplifier for amplifying a data signal transmitted to said base station.

3. The mobile communication system according to claim 1, wherein said base station changes the receive-system band-limiting characteristic so as to result in a relatively broad frequency band, when the volume of communication or the level of interference is relatively small, and
said mobile station groups change the transmit-system band-limiting characteristic so as to result in a relatively broad frequency band, in accordance with the information transmitted from said base station and changes the operating point of the transmit-system power amplifier so that an operation is steered into a nonlinear region.

4. The mobile communication system according to claim 2, wherein said base station changes the intervals between frequencies set up for said given communication channel and said adjacent communication channels so that said given communication channel band is relatively broad, when the volume of communication or the level of interference is relatively great, and
said mobile station groups changes the operating point of the transmit-system power amplifier so that an operation is steered into a nonlinear region.

5. The mobile communication system according to claim 1, wherein
said base station monitors the number of communicating mobile stations in said mobile station groups as indicating the volume of communication.

6. The mobile communication system according to claim 2, wherein
said base station monitors the number of communicating mobile stations in said mobile station groups as indicating the volume of communication.

7. The mobile communication system according to claim 1, wherein
said base station monitors nonlinear distortion signal components in the data signal grown from said given communication channel band and appearing in outputs from demodulators in said adjacent communication channel bands, as indicating the level of interference.

8. The mobile communication system according to claim 2, wherein
said base station monitors nonlinear distortion signal components in the data signal grown from said given communication channel band and appearing in outputs from demodulators in said adjacent communication channel bands, as indicating the level of interference.

9. A mobile communication method in which communication is performed between a plurality mobile station groups each comprising at least one mobile station and a base station, using a plurality of communication channel bands, wherein
said base station monitors volumes of communication in communication channel bands adjacent to a given communication channel used in communication with said mobile station groups, or monitors a level of interference with said adjacent communication channels from said given communication channel, changes a receive-system band-limiting characteristic in said given communication channel band in accordance with the volumes of communication or the level of interference and transmits information for changing a transmit-system band-limiting characteristic in said mobile station groups communicating in said given communication channel band, and
said mobile station groups change the transmit-system band-limiting characteristic in accordance with the information and changes an operating point of a transmit-system power amplifier for amplifying a data signal transmitted to said base station.

10. A mobile communication method in which communication is performed between a plurality mobile station groups each comprising at least one mobile station and a base station, using a plurality of communication channel bands, wherein
said base station monitors volumes of communication in communication channel bands adjacent to a given communication channel used in communication with said mobile station groups, or monitors a level of interference with said adjacent communication channels from said given communication channel, changes intervals between frequencies set up for said given communication channel and said adjacent communication channels, in accordance with the volumes of communication or the level of interference, and transmits information for changing the intervals to said mobile station groups,
said mobile station groups change the intervals in accordance with the information, and
said mobile station groups using said given communication channel band change an operating point of a transmit-system power amplifier for amplifying a data signal transmitted to said base station.

11. The mobile communication method according to claim 9, wherein
said base station changes the receive-system band-limiting characteristic so as to result in a relatively broad frequency band, when the volume of communication or the level of interference is relatively small, and
said mobile station groups change the transmit-system band-limiting characteristic so as to result in a relatively broad frequency band, in accordance with the information transmitted from said base station and changes the operating point of the transmit-system power amplifier so that an operation is steered into a nonlinear region.

12. The mobile communication method according to claim 10, wherein
said base station changes the intervals between frequencies set up for said given communication channel and said adjacent communication channels so that said given communication channel band is relatively broad, when the volume of communication or the level of interference is relatively great, and
said mobile station groups changes the operating point of the transmit-system power amplifier so that an operation is steered into a nonlinear region.

13. A base station communicating with a plurality of mobile station groups using a plurality of communication channel bands, characterized by monitoring volumes of communication in communication channel bands adjacent to a given communication channel used in communication with said mobile station groups, or monitoring a level of interference with said adjacent communication channels from said given communication channel, changing a receive-system band-limiting characteristic in said given communication channel band in accordance with the volumes of communication or the level of interference and transmitting information for changing a transmit-system band-limiting characteristic in said mobile station groups communicating in said given communication channel band.

14. A base station communicating with a plurality of mobile station groups using a plurality of communication channel bands, characterized by monitoring volumes of communication in communication channel bands adjacent to a given communication channel used in communication with said mobile station groups, or monitoring a level of interference with said adjacent communication channels from said given communication channel, changing intervals between frequencies set up for said given communication channel and said adjacent communication channels, in accordance with the volumes of communication or the level of interference, and transmitting information for changing the intervals to said mobile station groups.

15. The base station according to claim 13, characterized by changing the receive-system band-limiting characteristic so as to result in a relatively broad frequency band, when the volume of communication or the level of interference is relatively small.

16. The base station according to claim 14, characterized by changing the intervals between frequencies set up for said given communication channel and said adjacent communication channels so that said given communication channel band is relatively broad, when the volume of communication or the level of interference is relatively great.

17. A mobile station which constitutes each of a plurality of mobile station groups, each mobile station group comprising at least one mobile station, and which communicates with a base station using a plurality of communication channel bands, characterized by changing a transmit-system band-limiting characteristic in accordance with information transmitted by said base station to change the band-limiting characteristic of said mobile station groups communicating in a given communication channel band and changing an operating point of a transmit-system power amplifier for amplifying a data signal transmitted to said base station

18. A mobile station which constitutes each of a plurality of mobile station groups, each mobile station group comprising at least one mobile station, and which communicates with a base station using a plurality of communication channel bands, characterized by changing intervals between frequencies set up for said communication channel bands, in accordance with information transmitted from said base station to change the intervals, and, when said mobile station constitutes a mobile station group communicating in a given communication channel with said base station, changing an operating point of a transmit-system power amplifier for amplifying a data signal transmitted to said base station.

19. The mobile station according to claim 17, characterized by changing the transmit-system band-limiting characteristic so as to result in a relatively broad frequency band, in accordance with information transmitted from said base station, and changing the operating point of the transmit-system power amplifier so that an operation is steered into a nonlinear region.

20. The mobile station according to claim 18, characterized by changing the operating point of the transmit-system power amplifier so that an operation is steered into a nonlinear region, when said mobile station constitutes a mobile station group communicating in said given communication channel band.
